(19) United States
(12) Patent Application Publication
(10) Pub. No.: US 2022/0009450 A1
(43) Pub. Date: Jan. 13, 2022

(54) WIPER FRAME, IN PARTICULAR FOR A MOTOR VEHICLE

(71) Applicant: Robert Bosch GmbH, Stuttgart (DE)

(72) Inventor: Reiner Lay, Aachen (DE)

(21) Appl. No.: 17/294,056

(22) PCT Filed: Nov. 12, 2019
(86) PCT No.: PCT/EP2019/080915

§ 371 Date: May 14, 2021

(30) Foreign Application Priority Data
Nov. 15, 2018 (DE) 10 2018 219 558.7

(51) Int. Cl. B60S 1/38

(52) U.S. Cl. CPC B60S 1/3848; B60S 2001/3836; B60S 2001/3829

(57) ABSTRACT

The invention relates to a wiper frame (10), particularly for a motor vehicle. Said wiper frame comprises a support element (14) and a wiper blade (12) that has a cavity (20), and a wiper blade lip (16). According to the invention, the wiper blade lip (16) is rigidly secured to the wiper blade (12).

### BACKGROUND

The invention relates to a wiper blade, in particular for a motor vehicle.

Numerous wiper blades comprising a carrier element and a wiper strip with a cavity and a wiper lip are already known.

Wiper blades of this type are frequently relatively loud during operation, in particular in the turning points at which the movement direction of the wiper blade reverses.

Further prior art is disclosed in US 2008/189897A, in DE 10 2007 050 171 A1, in DE 10 2007 039 563 A1 and in WO 2011/000403 A1.

### SUMMARY

The wiper blade according to the invention having the features of the main claim has the advantage that the wiper lip is fastened rigidly to the wiper strip. In this way, the wiper lip is effectively prevented from folding down in the turning points, this resulting in a significant reduction in noise, in particular in the turning points.

Advantageous developments and improvements of the features specified in the main claim emerge from the measures set out in the dependent claims.

It is particularly advantageous when the cavity is arranged between carrier element and wiper lip, since in this way optimum noise damping is ensured.

It is also of advantage when the carrier element is arranged outside the cavity, since this also significantly improves or mitigates the development of noise.

It can also be considered to be advantageous when the cavity has a substantially round cross section and does not have any supports at all in its interior. The generation of noise is significantly reduced in this way, too.

The wiper lip here ideally has only a single wiper edge. A wiper lip can be formed from a thermoplastic material simply and cost-effectively, this further reducing the noises.

It is particularly advantageous when the cavity is hermetically closed.

In this respect, it is particularly advantageous when the cavity is filled with gas, liquid or gel.

It can also be considered to be advantageous when the wiper strip is fastened rigidly to the carrier element. As a result, optimum guidance of the wiper strip is ensured. The noise-reducing design of the wiper strip is fully manifested in this way.

In one simple and cost-effective embodiment, an adapter element is fastened to the carrier element in an advantageous manner.

### BRIEF DESCRIPTION OF THE DRAWINGS

An exemplary embodiment of the invention is illustrated in the drawings and explained in more detail in the description which follows. In the drawings:

FIG. 1 shows a schematic view of a wiper blade according to the invention and

FIG. 2 shows a schematic illustration of a cross section through a wiper blade according to the invention.

### DETAILED DESCRIPTION

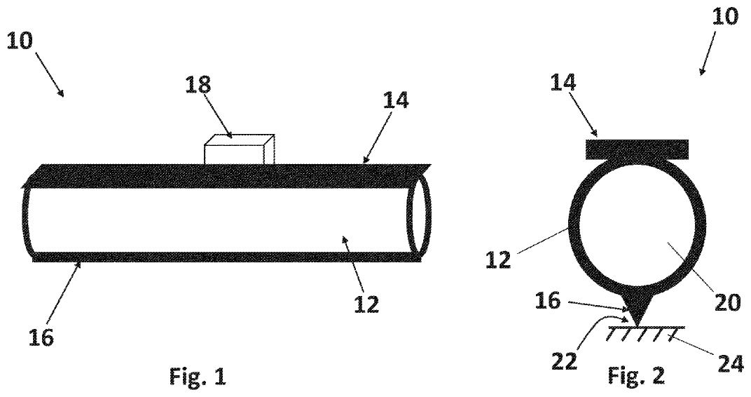

FIG. 1 shows a schematic illustration of a wiper blade 10 according to the invention. The wiper blade 10 substantially comprises a wiper strip 12, which is fastened to a carrier element 14. The wiper lip 16 is arranged on that side of the wiper strip 12 which faces away from the carrier element 14. Arranged on that side of the carrier element 14 which faces away from the wiper strip 12 is an adapter element 18, which serves to fasten the wiper blade 10 to a wiper arm (which is not depicted here). In this respect, the wiper strip 12 is fastened rigidly to the carrier element 14. The wiper lip 16 is similarly fastened rigidly to the wiper strip 12 or formed in one piece therewith.

FIG. 2 shows the wiper blade 10 from FIG. 1 in cross section.

The carrier element 14 is designed as a cuboidal, that is to say cross-sectionally rectangular, metal band of spring steel and extends over the entire length of the wiper blade 10. Said metal band is between 0.5 millimeter and 2 millimeters thick and between 10 centimeters and 100 centimeters long. Fastened to the carrier element 14 is the wiper strip 12, which has a circular cavity 20 in its interior. Arranged on that side of the wiper strip 12 which faces away from the carrier element 14 is the wiper lip 16, which is fastened rigidly to the wiper strip 12 and has a cross-sectionally approximately triangular form. The wiper lip 16 is connected to the wiper strip 12 in such a way that a single wiper edge 22 is arranged on that side of the wiper lip 16 which faces away from the wiper strip 12. After assembly on the motor vehicle, this wiper edge 22 rests on a windshield 24. The height of the wiper lip 16 is approximately 5 millimeters, but can be varied between 1 millimeter and 15 millimeters in accordance with the intended use. The wiper strip 12 has a substantially round cross section and is therefore configured in the form of a hose, with the result that the cavity 20 is formed in the interior. The wall thickness between the outer boundary of the cavity 20 and the outer contour of the wiper strip 12 is between 0.3 millimeter and 2 millimeters.

The function of the wiper blade 10 according to the invention is described below.

During operation, the wiper blade 10 swings back and forth between two reversal positions on the windshield 24 of the motor vehicle. In the case of a conventional wiper blade, two wiper edges are provided as a rule, the wiper lip being fastened movably to the wiper strip. The wiper strip then in each case drags the wiper lip behind it during the movement, with the result that a wiper edge rests on the windshield 24. In the reversal position, the movement direction is changed. The wiper lip tilts into the other dragging position and continues its movement on the other wiper edge. In the case of the wiper blade 10 according to the invention, only one wiper edge 22 is provided and tilting of this type is avoided by virtue of the rigid fastening of the wiper lip 16 to the wiper strip 12.

The cavity 20 is filled with air, but can also be filled with a liquid or with a gel, in order to improve the damping between the carrier element 14 and the wiper lip 16 and at the same time to ensure optimum contact between wiper lip 16 and windshield 24. For this purpose, the cavity 20 of the wiper strip 12 should be hermetically closed in order to prevent the damping liquid and/or the gel or the gas from escaping.

To fasten the wiper strip 12 to the carrier element 14, it is possible to provide on the wiper strip 12 a fastening space, in which the carrier element 14 is pushed. It is similarly possible to provide on the wiper strip 12 a bracket element, into which the carrier element 14 is bracketed. The bracket element can be formed in one piece with the wiper strip 12 in a similar manner to the receiving space and thus can be produced at the same time as the wiper strip 12 and the wiper lip 16, for example in a multi-component extrusion process.

The adapter element 18 is formed from metal as a cast or sheet-metal part and welded onto the carrier element 14. However, said adapter element can also be connected by a bracket. In one variation, the carrier element 14 is formed from plastic. The adapter element 18 can also be formed in one piece with the carrier element 14. In this respect, the fastening element 18 can be fastened to the carrier element 14 for example by ultrasonic welding.

No solid elements supporting the wiper lip 16 in any way are provided within the cavity 20, with the result that free movement of the wiper lip 16 is ensured. In one variation of the invention, the cavity 20 can also have an elliptical form or cuboidal form. A rhomboidal form is also possible.

The wiper lip is formed from thermoplastic material, for example PU, PA, HMW-PE. Materials particularly suitable here are those exhibiting improved abrasion characteristics over normal, conventional rubber. The wiper strip 12 itself, which forms the cavity 20, can similarly be formed from thermoplastic material, with the result that the wiper strip 12 with the wiper rubber 16 can also be produced in a one-component extrusion process.

The carrier element 14 is cut from a long steel strip, in particular spring steel, and has the same width along its length. The carrier element 14 is also pre-bent in such a way that its curvature is greater than the maximum curvature of the windshield for which the wiper blade 10 is to be used. In any case, the carrier element 14 is pre-bent such that an optimum bearing force distribution of the wiper edge 22 on the windshield 24 is ensured.

1. A wiper blade (10) comprising a carrier element (14), a wiper strip (12) which comprises a cavity (20), and a wiper lip (16), characterized in that the wiper lip (16) is fastened rigidly to the wiper strip (12).

2. The wiper blade (10) as claimed in claim 1, characterized in that the cavity (20) is arranged between the carrier element (14) and the wiper lip (16).

3. The wiper blade (10) as claimed in claim 1, characterized in that the carrier element (14) is arranged outside the cavity (20).

4. The wiper blade (10) as claimed in claim 1, characterized in that the cavity (20) is formed with a substantially round cross section particular in a manner without support.

5. The wiper blade (10) as claimed in claim 1, characterized in that the wiper lip (16) in cross section has only a single wiper edge (22).

6. The wiper blade (10) as claimed in claim 1, characterized in that the wiper lip (16) is formed from thermoplastic material.

7. The wiper blade (10) as claimed in claim 1, characterized in that the cavity (20) is hermetically closed.

8. The wiper blade (10) as claimed in claim 1, characterized in that the cavity (20) is filled with gas, liquid or gel.

9. The wiper blade (10) as claimed in claim 1, characterized in that the wiper strip (12) is fastened rigidly to the carrier element (14).

10. The wiper blade (10) as claimed in claim 1, characterized in that an adapter element (18) is fastened to the carrier element (14).

11. The wiper blade (10) as claimed in claim 1, characterized in that the wiper blade is configured for use on a motor vehicle.

12. The wiper blade (10) as claimed in claim 4, characterized in that the cavity is formed without supports in an interior of the cavity.
